(19) United States
(12) Patent Application Publication
(10) Pub. No.: US 2026/0371336 A1
(43) Pub. Date: Nov. 19, 2026

(54) Applicability Report for AI Based Cross Frequency Beam Prediction using UE Side Model

(71) Applicant: Apple Inc., Cupertino, CA (US)

(72) Inventors: Huaning NIU, San Jose, CA (US); Boqiang FAN, San Diego, CA (US); Hyukjin CHAE, Chula Vista, CA (US); Oliver SHIH, San Jose, CA (US); Wanshi CHEN, San Diego, CA (US); Weidong YANG, San Diego, CA (US)

(21) Appl. No.: 19/209,704

(22) Filed: May 15, 2025

(51) Int. Cl. H04W 72/044; H04B 7/0456; H04W 24/08; H04W 64/00

(52) U.S. Cl. CPC H04W 72/046; H04B 7/0456; H04W 24/08; H04W 64/006

(57) ABSTRACT

An apparatus configured to generate, for transmission to a network, a capability report indicating support of cross frequency beam prediction by a model stored in the memory, process, based on signaling from the network, a configuration for reporting applicable functionalities for the model, the configuration including at least a first associated identifier (ID), the first associated ID associated with beam transmission parameters by a first cell of the network providing a first component carrier (CC) in a first frequency band and with beam transmission parameters by a second cell of the network providing a second CC in a second frequency band and generate, for transmission to the network, a response indicating the applicable functionalities based at least in part on the first associated ID.

### BACKGROUND

Artificial intelligence (AI) and/or machine learning (ML) processes, e.g., deep learning neural networks, may be used to augment operations for the air interface in a cellular radio access network (RAN), e.g., 5G New Radio (NR) RAN, 6G RAN, etc. The use cases of AI/ML for the air interface include beam management (BM).

### SUMMARY

Some example embodiments are related to an apparatus having memory coupled to processing circuitry, the processing circuitry configured to generate, for transmission to a network, a capability report indicating support of cross frequency beam prediction by a model stored in the memory, process, based on signaling from the network, a configuration for reporting applicable functionalities for the model, the configuration including at least a first associated identifier (ID), the first associated ID associated with beam transmission parameters by a first cell of the network providing a first component carrier (CC) in a first frequency band and with beam transmission parameters by a second cell of the network providing a second CC in a second frequency band and generate, for transmission to the network, a response indicating the applicable functionalities based at least in part on the first associated ID.

Other example embodiments are related to an apparatus having memory coupled to processing circuitry, the processing circuitry configured to process, based on signaling from the network, a configuration for data collection for training a model for cross frequency beam prediction, the configuration at least including a first reference signal (RS) configuration for a first cell of the network providing a first component carrier (CC), a second RS configuration for a second cell of the network providing a second CC, and a first associated identifier (ID), the first associated ID associated with beam transmission parameters by the first cell in a first frequency band and with beam transmission parameters by the second cell in a second frequency band, measure, based on signaling from the first cell, first RS to generate first RS measurements, measure, based on signaling from the second cell, second RS to generate second RS measurements, and store the first RS measurements and the second RS measurements in association with the associated ID.

### BRIEF DESCRIPTION OF THE DRAWINGS

FIG. 1 shows a diagram illustrating a beam management procedure according to one example.

FIG. 2 shows a diagram for cross-frequency beam prediction according to one example.

FIG. 3 shows a signaling diagram for activating an functionality according to one example.

FIG. 4 shows a signaling diagram for training data collection for UE side inferencing for cross frequency beam measurement according to various example embodiments.

FIG. 5 shows a signaling diagram for inference for UE side inferencing for cross frequency beam measurement according to various example embodiments.

FIG. 6 shows a diagram including an association between a virtualization of a FR1 CSI-RS resource set and a FR2 beam pattern according to various example embodiments.

FIG. 7 shows a signaling diagram for a first option for data collection for a UE side model for cross frequency beam measurement according to various example embodiments.

FIG. 8 shows a signaling diagram for a second option for data collection for a UE side model for cross frequency beam measurement according to various example embodiments.

FIG. 9 shows a signaling diagram for inference for a

UE side model for cross frequency beam measurement according to various example embodiments.

FIG. 10 shows an example network arrangement according to various example embodiments.

FIG. 11 shows an example UE according to various example embodiments.

FIG. 12 shows an example base station according to various example embodiments.

### DETAILED DESCRIPTION

The example embodiments may be further understood with reference to the following description and the related appended drawings, wherein like elements are provided with the same reference numerals. The example embodiments relate to operations for applicability reporting for models employed by a user equipment (UE) for beam management (BM). In particular, the example embodiments relate to UE-side models for cross-frequency beam prediction. In some example embodiments, the models may be artificial intelligence and/or machine learning (AI/ML) models. In other example embodiments, the models may be deterministically derived models (e.g., look up table, matrices, etc.).

Some example embodiments relate to operations for UE reporting applicable functionalities for cross frequency beam prediction in view of network-side additional conditions indicated by the network by an associated identifier (associated ID). Additional example embodiments relate to training and inference of the UE-side model for cross frequency beam prediction including signaling details for consistency between training and inference.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange signaling and/or data with the network. Therefore, the UE as described herein is used to represent any electronic component.

The example embodiments are also described with reference to a 5G New Radio (NR) network. However, reference to a 5G NR network is merely provided for illustrative purposes. The example embodiments may be utilized with any network implementing AI/ML beam management functionalities similar to those described herein, e.g., 5G-Advanced network, 6G network, etc. The example embodiments may be utilized with a 6G network following certain general procedures of the 5G NR network.

The example embodiments are also described with regard to radio resource management (RRM), in particular, beam management (BM). Beam management generally refers to a set of procedures configured to acquire and maintain a beam between a base station or TRP and a UE. The terms P1, P2 and P3 refer to processes for beam management during initial access and while in the CONNECTED state. In the P1 process, the base station (e.g., gNB) performs Tx beam sweeping of synchronization signal blocks (SSBs), typically from a set of different beams, and the UE performs reception (Rx) wide beam sweeping from a set of different beams. The UE measures the signal strength (e.g., Reference Signal Received Power (RSRP)) of each of the SSBs of the received beams and selects the best beam to report to the gNB. In the P2 process, the gNB performs beam refinement by performing Tx beam sweeping of Channel State Information-Reference Signal (CSI-RS), possibly from a smaller set of beams based on the wideband in the P1 process, and the UE receives the fine beam using the wide Rx beam from the P1 process. The P2 Tx beam sweeping may be narrower than that of P1. The UE measures the signal strength (e.g., RSRP) of the CSI-RS of the received beams and selects the best beam to report to the gNB. In the P3 process the gNB (TRP) repeatedly transmits the same Tx beam and the UE refines its Rx beam, by performing Rx narrow beam sweeping.

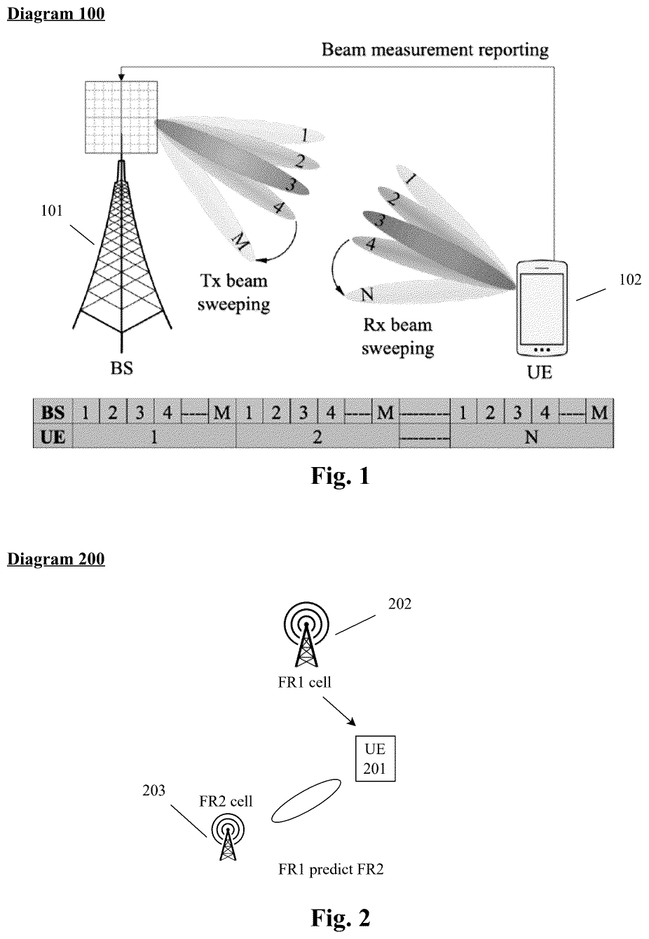

FIG. 1 shows a diagram 100 illustrating a beam management procedure according to one example. Legacy NR systems rely on beam sweeping to acquire the beam information of the gNB and UE, e.g., in the P1 procedure. A base station 101 transmits SSB in a beam sweeping manner and repeats with SSB transmission periodicity. The base station 101 may transmit M Tx beams per beam sweep. A UE 102 performs Rx beam sweeping of each SSB burst. The UE 102 may use a single Rx beam for each Tx beam sweep and adjust the Rx beam for subsequent Tx beam sweeps for a total of N Rx beams. Accordingly, the total number of UE 102 measurements is M×N. The delay incurred by these measurements, according to existing procedures, may be relatively long. For example, assuming 40 ms SSB periodicity, the total delay is at least 40xN.

The example embodiments are further described with regard to channel state information reference signal (CSI-RS) feedback and synchronization signal block (SSB) feedback. CSI-RS feedback may comprise codebook-based reporting including some or all of the following information: a CSI-RS resource index (CRI), a Rank Indicator (RI), a Precoder Matrix Indicator (PMI), a Layer Indicator (LI), and/or a Channel Quality Indicator (CQI). PMI feedback may explicitly or implicitly indicate a UE preferred precoder based on a type II codebook structure, e.g., a spatial component corresponding to the spatial basis of the UE preferred precoder (e.g., W₁), a frequency component corresponding to the frequency basis the UE preferred precoder (e.g., W_{f}), a time/Doppler component corresponding to the time/Doppler basis of the UE preferred precoder (e.g., W_{d}) and a linear combination coefficient component corresponding to the combination coefficient of the UE preferred precoder (e.g., W₂). Each component of the PMI may be associated with one or more parameters that are identified by a codebook index hard encoded in the 3GPP Specifications. There are various different types of codebook indices mapped to a variety of different formulas and tables in the 3GPP Specifications and these codebook indices may be used in the manner in which they are defined in the 3GPP Specifications. SSB feedback may have a coarser granularity relative to CSI-RS feedback. SSB feedback may comprise, e.g., beam indices (SSB resource indicator (SSBRI)) having a strongest signal strength.

The example embodiments are also described with regard to AI/ML-based beam management (BM). An AI/ML model may be employed for beam prediction to reduce overhead/latency and improve beam selection. The AI/ML model may be employed for beam prediction in the time domain and/or the spatial domain according to Rel-18 BM procedures. In both time and spatial prediction, a set of downlink beams may be measured and used as input to the AI/ML model to predict the best beam within another set of downlink beams. In some example embodiments, the measured parameter/quantity may be L1-RSRP. However, the example embodiments are not limited to this parameter. The measured set of downlink beams may be referred to as “Set B” and the predicted set of downlink beams may be referred to as “Set A.” Set B may be a subset of Set A, or Set B may be different from Set A. For example, the base station may be capable of transmitting 64 beams, but the base station may transmit only 4 beams or 8 beams as the Set B of beams. The AI/ML model may then predict a larger set of beams, e.g., the Set A of beams.

The input into the AI/ML model may be measurement results based on measurements performed by the UE on the Set B of beams. The inputs may also include other inputs such as beam forming assumptions and configuration assumptions used by a base station to transmit the Set B of beams. The AI/ML model may use these inputs to predict a beam report for a Set A of beams, which may include a best beam from the Set A and/or L1-RSRP. The AI/ML model may reside at the UE or at the network (e.g., base station).

Beam management Case 1 (BM-Case1) relates to spatial-domain DL Tx beam prediction for a Set A of beams based on measurement results of a Set B of beams. In BM Case 1, the UE measures a subset of beams (Set B) for input to the AI/ML model. The output of the AI/ML model may comprise a quality of all beams and/or the ID of the Top-K beams. In some cases, a wide beam may predict a narrow beam. In other cases, a sub-sampled set of beams may predict a full set of beams. Beam management Case 2 (BM-Case2) relates to temporal DL Tx beam prediction for Set A of beams based on the historic measurement results of Set B of beams. BM-Case2 may include time and spatial domain prediction. In BM Case 2, the best beam at the future time T+m may be predicted by the AI/ML model based on the measurement results of more than one historical measurement time instance. The measurement results of the historical time instance may include the L1-RSRP of beams in set B in the last N history measurement instance. The number of predicted future time instances may be at least one. Each predicted future time instance may include multiple predicted beams. Both BM-Case1 and BM-Case2 are used in RRC connected mode, e.g., the UE is already connected to FR2 cell.

For AI based cross frequency beam management, it is an objective to extend beam prediction to the frequency domain by further exploring frequency/time/spatial domain correlation in 6G development. It is an objective to enable cross-frequency beam prediction, e.g., prediction of FR2 beams or FR3 beams based on measurements of FR1 beams, in 6G.

FIG. 2 shows a diagram 200 for cross-frequency beam prediction according to one example. In this example, a UE 201 connected to an FR1 cell 202 predicts beam information for an FR2 cell 203. One example of a use case for this functionality comprises a UE on FR1 adding FR2 when the traffic load is high, or the predicted traffic is high if traffic prediction is used. The UE may report predicted FR2 beam or FR2 L1-RSRP to the network and, based on the report, the network may decide to activate the FR2 cell (e.g., as a secondary cell (SCell) in a carrier aggregation (CA) deployment).

For AI-based cross-frequency beam prediction, it is an objective to explore the embedded position information between the FR1 and FR2 cells. In this case, a localized model may naturally perform better than a generalized model. Accordingly, the UE will need to be trained in view of local conditions, e.g., network-side additional conditions. This requires applicability reporting to ensure the UE has a valid model for inferencing after deployment.

AI/ML model life cycle management (LCM) refers to the development, deployment, and management of an AI/ML model. There are two main categories of AI/ML LCM in the Third Generation Partnership (3GPP) Technical Specification (TS), in particular, functionality-based LCM and model ID-based LCM. In functionality-based LCM, a functionality refers to a feature enabled by a configuration. For both functionality-based and model ID-based LCM, the UE may store the AI/ML model (with the associated model ID or functionality/configuration) and exchange this information with the network as capability information. Each AI/ML model ID or AI/ML functionality/configuration may be associated with conditions such that the model is valid only for a particular network vendor, cell site, and/or frequency band. Generally, the number of AI/ML models stored by the UE may be kept low in order to reduce the complexity, model storage and AI/ML model transfer requirements. AI/ML models may be transferred to the UE through some collaboration with the network. These AI/ML modeling frameworks are not mutually exclusive and may be used in combination.

The concept of additional conditions refers to non-standardized variables critical to AI/ML model training and operation. For example, in AI/ML-driven beam management, factors such as network topology (e.g., cell layout, antenna configurations) or UE-specific parameters (e.g., mobility status) directly influence model selection during deployment. However, standardizing these variables is impractical, as they often involve proprietary implementations or sensitive operational data. Even though these variables may be used for training the AI/ML model and the AI/ML model operation requires these variables as input, these variables may not be standardized due to disclosure of proprietary information. Thus, classifying these variables as additional conditions may enable optimal AI/ML operation.

The associated ID is configured by the network as an abstract training data identifier and is used to reflect network-side additional conditions which may not be specified. The associated ID may correspond to particular sets of beam angles, beamwidths, antenna spacing, tilt angle, etc. The network may assign a separate associated ID for various different sets of conditions that affect beam transmission. However, not every difference in network-side additional conditions or network implementation has impacts on the UE side, e.g., UE assumptions, model training and model inference. Therefore, not every different network-side additional condition requires the assignment of a separate associated ID.

The term “functionality,” as used in 3GPP standards, was recently clarified, particularly in view of recent work on beam management. It is currently agreed that the term “functionality” may refer to one of at least three different types of functionalities including “supported functionalities,” “applicable functionalities,” and “activated functionalities.” Supported functionality may refer to UE-capability information/parameters, e.g., Rel-19 AI/ML-enabled Features or Feature Groups (FG). Applicable functionality may refer to inference-related parameters, e.g., the associated ID, reflecting additional conditions, e.g., beam transmission parameters, which may be indicated in CSI-ReportConfig for inference configuration. Activated functionality may refer to functionalities enabled for the UE based on the CSI framework.

It was further agreed that the activation of an AI/ML functionality may comprise a five step signaling procedure covering the main signaling operations from UE capability enquiry up to network provisioning and activation of the AI/ML functionality. The general framework for dynamic AI functionality reporting may comprise an approach based on RRC reconfiguration complete (RRCReconfigurationComplete) or an approach based on uplink assistance information (UAI). This general framework applies to all UE cases including AI based BM, positioning, and CSI compression.

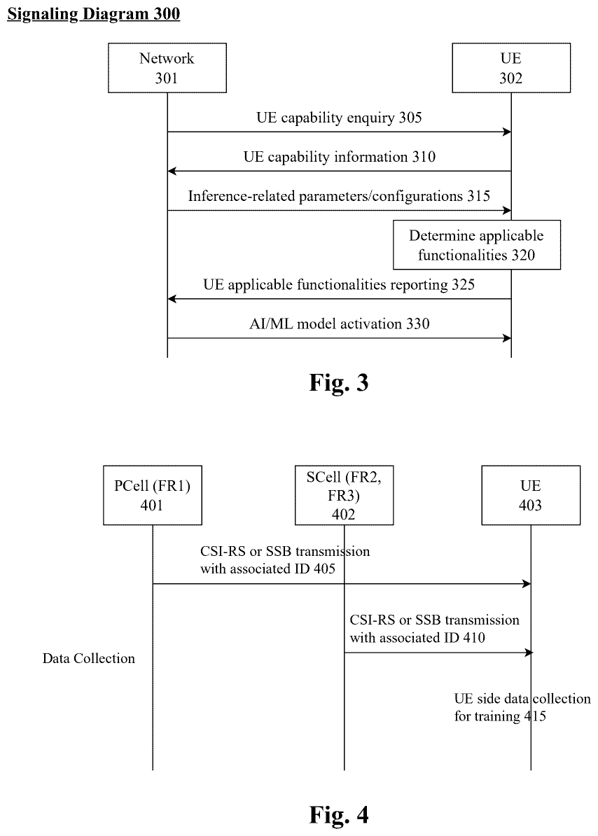

FIG. 3 shows a signaling diagram 300 for activating an functionality according to one example. The signaling diagram 300 includes a network 301, e.g., a gNB, and a UE 302.

In a first operation (305) the network 301 sends a UE capability inquiry (UECapabilityEnquiry) message to the UE 302 to initiate the procedure for the UE 302 to report its AI/ML supported functionalities.

In a second operation (310), the UE 302 sends a UE capability information message (UECapabilityInformation) to the network 301 containing supported functionalities at the UE side. The functionalities supported in 310 may have relatively low granularity, e.g., BMCase1, BMCase2, etc.

In a third operation (315), the network 301 provides one or more configurations to the UE (RRCReconfiguration). In one example, the UE is enabled for uplink assistance information (UAI) reporting via OtherConfig. In another example, the network 301 may indicate network-side additional conditions corresponding to inference-related parameters.

In 320, the UE determines applicable functionalities based on the network-side additional conditions (if provided), UE-side additional conditions (internally known by UE) and model availability in the device.

In a fourth operation (325), the UE reports applicable functionalities in scenarios including, e.g., upon being configured to provide applicable functionalities, upon change of applicable functionalities (e.g., via UAI), or as a response to network-side additional conditions requesting applicable functionality reporting in the third operation. In a fifth operation (330), the network 301 activates an AI/ML functionality for the UE 302 (in RRCReconfiguration).

As shown above, in the fourth operation (325), applicable functionalities may be reported by the UE by UAI and by RRCReconfigurationComplete. It is an objective to align the signaling design for these cases. The content of the applicability reporting is for further study.

According to various example embodiments, operations are described for applicability reporting for cross-frequency beam prediction. The example embodiments described below are described with regard to the operations 305-330 described above in FIG. 3. Some example embodiments are described with regard to the use case in which the UE uses FR1 channel feedback to predict FR2 beams. However, the example embodiments are not limited to this use case. For example, in other embodiments, the UE may use FR1 channel feedback to predict FR3 beams or the UE may use FR3 channel feedback to predict FR2 beams. In still other embodiments, the UE may use downlink channel feedback to predict uplink beams in frequency division duplexing (FDD) bands, e.g., DL CSI-RS may predict UL SRS.

In some embodiments, operations are described for ensuring consistency between training and inferencing for cross frequency beam management using a UE-side inference model. In some embodiments, a data collection configuration may include an FR1 CSI-RS resource set, FR2 beam indices (SSBRI/CRI) in association with a SSB or CSI-RS resource set, and the associated ID. The associated ID indicated during data collection for training may relate to, e.g., the association between the network FR1 beam and the network FR2 beam pattern, to be described in greater detail below with regard to FIG. 6. The CSI-RS configuration may be sent by the FR1 cell or the FR2 cell if the UE is already connected with FR2 cell.

FIG. 4 shows a signaling diagram 400 for training data collection for UE side inferencing for cross frequency beam measurement according to various example embodiments. The signaling diagram 400 includes a PCell 401 providing an FR1 CC, an SCell 402 providing an FR2 or FR3 CC, and a UE 403. The PCell 401 may configure the UE for data collection by configuring CSI-RS or SSB resources for the FR1 cell and for the FR2 cell and an associated ID used for data collection. The PCell 401 transmits CSI-RS or SSB in the configured resources (405) and the SCell 402 transmits CSI-RS or SSB in the configured resources (410). The UE 403 measures the resources for UE side data collection for training (415). The UE 403 stores the measurements on the PCell and the SCell with the associated ID. The UE 403 may train a model with the measurement data, e.g., in offline training, and associate the associated ID with the trained model

For inference, when the UE receives the CSI-RS configuration of FR1 cell and FR2 cell, with the beam index indication associated with a certain associated ID, the UE may predict the FR2 beams based on the FR1 RS measurements.

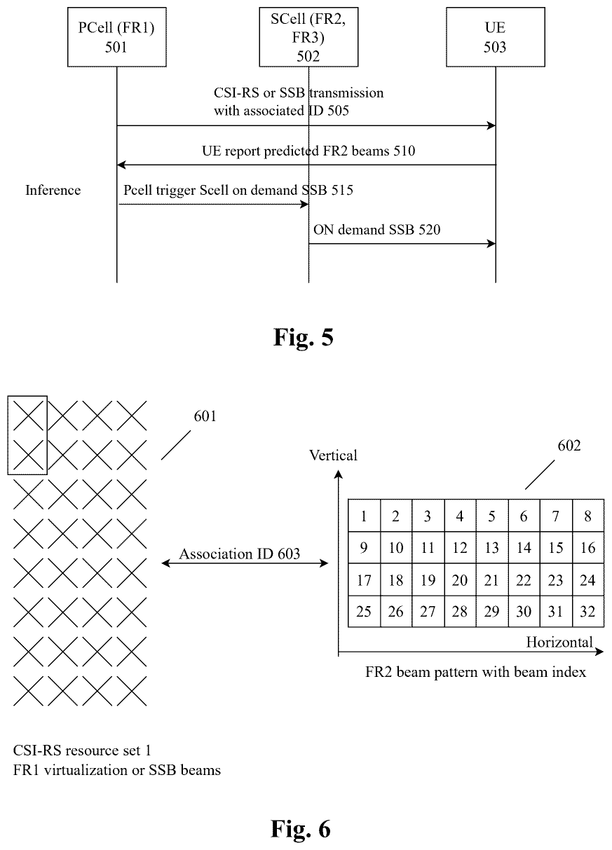

FIG. 5 shows a signaling diagram 500 for inference for UE side inferencing for cross frequency beam measurement according to various example embodiments. The signaling diagram 500 includes a PCell 501 providing an FR1 component carrier, an SCell 502 providing an FR2 or FR3 CC, and a UE 503. The PCell 501 transmits CSI-RS or SSB in the configured FR1 resources (505) and the UE 503 reports predicted FR2/FR3 beams (510). Based on the beam report, the PCell 501 may trigger the SCell 502 to transmit on-demand SSB (515), e.g., for SCell activation, for one of the predicted beams. Accordingly, the SCell 502 transmits on-demand SSB (520) for SCell activation.

In view of the above, the associated ID is used for labeling the training data so that the UE may store a model with the associated ID. For inference, the network indicates the associated ID and the UE may measure the FR1 beams to predict the FR2 beams. The detailed signaling steps for training and inference are described in greater detail below. In particular, for inference, the five step process described above with regard to the signaling diagram 300 of FIG. 3 may be used for reporting applicable functionalities and activating a model residing on the UE.

In some embodiments, the UE may report the capability of UE side inferencing for cross frequency beam management. These embodiments may relate to the first operation (305) and second operation (310) described above in which the network transmits a UE capability request (UECapabilityEnquiry) to the UE and in response the UE sends a UE capability information message (UECapabilityInformation) to the network containing supported cross-frequency beam management functionalities for a UE-side model. These embodiments comprise static UE capability reporting for indicating general support for cross frequency beam management. In some embodiments, the capability report may include combinations of frequency ranges supported for cross frequency beam management, e.g., a frequency range for the primary component carrier (PCC) of a primary cell (PCell) (providing the RS measured by the UE) and a frequency range for the secondary component carrier (SCC) of a secondary cell (SCell) (to be predicted by the PCC measurements). In various embodiments, the UE may report a capability for {FR1, FR2} inter-band combinations, {FR1, FR3} inter-band combinations, and/or {FR3, FR2} inter-band combinations.

In some embodiments, the capability report may include supported PCell/SCell antenna configurations. In these embodiments, the PCell transmits CSI-RS according to an antenna virtualization that may be up to network implementation. For example, the PCell may transmit with 32 ports or 64 ports. The model input comprises CSI-RS measurements, e.g., PMI. The model output may comprise CSI or SSB measurement predictions for the SCell. The SCell transmits CSI-RS/SSB according to a beam pattern. For example, the SCell may transmit 16 beams or 32 beams.

In various embodiments, the UE may report a capability for combinations of PCell antenna ports and a number of SCell beams. In various embodiment, the UE may report a capability for [32 ports, 16 beams] combinations, [64 ports, 16 beams] combinations, and/or [64 ports, 32 beams] combinations.

In some embodiments, the UE may report a capability for FDD operations in which the UE uses DL CSI-RS measurement to predict UL SRS beam in FDD bands.

Accordingly, the network is informed of static UE capabilities, e.g., general support for cross-frequency beam management. However, an additional exchange of information is necessary to determine whether a UE-side model should be activated in view of network-side parameters (e.g., additional conditions) and dynamic UE-side information, e.g., mobility or location/related conditions to be described in greater detail below.

In various embodiments, the network side additional conditions include an association between the FR1 antenna port virtualization and the FR2 beam pattern, e.g., codebook. The antenna virtualization is generally up to network implementation and is typically transparent to the UE. Similarly, the codebook is generally up to network implementation. However, these factors may be abstracted under an association ID label.

FIG. 6 shows a diagram 600 including an association between a virtualization of a FR1 CSI-RS resource set and a FR2 beam pattern according to various example embodiments. In this example, an FR1 antenna virtualization 601 and a FR2 beam pattern 602 are associated with an association ID 603.

In some embodiments, the association ID framework may comprise the following two options. In a first option, the FR1 antenna port mapping to antennas (i.e., TxRU virtualization) is defined by one ID (e.g., Antenna port virtualization ID). It is noted that the antenna port virtualization may be useful for multiple different MIMO related prediction, including R19 MIMO CSI prediction and CSI compression, and 6G CSI-RS overhead reduction in port domain. In these embodiments, the FR2 beam codebook is defined by a separate ID (e.g., beam book ID). The association is defined by linking the above two IDs together, e.g., Association ID: {Antenna port ID, beam book ID}. In one embodiment, the 1^{st} ID representing antenna port can be called association ID 1, and 2^{nd} ID representing the FR2 codebook is association ID 2. We define paired association linking association ID 1 and 2 together.

In a second option, only one association ID is defined for this cross beam prediction use case. In these embodiments, the Association ID may identify {CSI-RS resource set ID in PCell, SSB configuration or CSI-RS resource set ID in SCell}.

The above examples are cross FR1 and FR2 prediction. For FR3, association ID may depend on FR3 antenna architecture at the gNB. If an FR3 gNB reuses an FR1-like architecture, then the ID 2 may represent the antenna port. If the FR3 gNB reuses an FR2 -like architecture, then the ID2 may represent the FR3 codebook for beamforming.

Referring to step 315 of the signaling diagram 300 of FIG. 3 above, the network indicates inference-related parameters including a CSI-RS resource set or SSB configuration including the association ID in an RRC Reconfiguration. The inference-related parameters may further include network parameters such as, e.g., general changes regarding an SCell deployment.

Referring to step 320 of the signaling diagram 300 of FIG. 3 above, the UE determines supported applicable functionalities. The UE determines whether any stored models are applicable to the current UE deployment in view of network-side considerations and UE-side considerations.

In some embodiments, the UE determines the applicability based on the association ID (i.e., network-side additional conditions). In some embodiments, on top of the association ID, the UE determines the applicability based on UE side information such as LoS or nLOS condition, indoor and outdoor condition, mobility, and UE location. With regard to LOS/NLOS and indoor/outdoor, in one example, the UE-side model may have much better accuracy in LOS conditions and/or outdoor conditions. With regard to mobility, in one example, SCell addition may be preferred in a low mobility UE state and, if the UE is in a high mobility state, applying the model may be suboptimal. In some embodiments, the UE determines the applicability based on network indication of general changes. In one example, if the network indicates a subset of SCells within the PCell coverage, the UE-side model may not perform well on the indicated SCells.

Accordingly, in view of the above, the UE may determine applicable functionalities based on the associated ID, UE-side information, and/or explicit network information.

In some embodiments, the detailed signaling procedure for data collection is described. For data collection, the UE is in connected mode on both the PCell and the SCell.

In a first option, the PCell sends the CSI-RS configuration of the PCell to the UE and the SCell sends the SSB or CSI-RS configuration of the SCell to the UE. The association between the PCell and the Scell may be indicated as part of the PCell configuration for data collection or as part of both the PCell and the SCell configuration for data collection. It is noted that this option may be suitable in combination with an associated ID framework in which the PCell transmission parameters and the SCell transmission parameters have separate IDs that are linked in an associated ID, as described above.

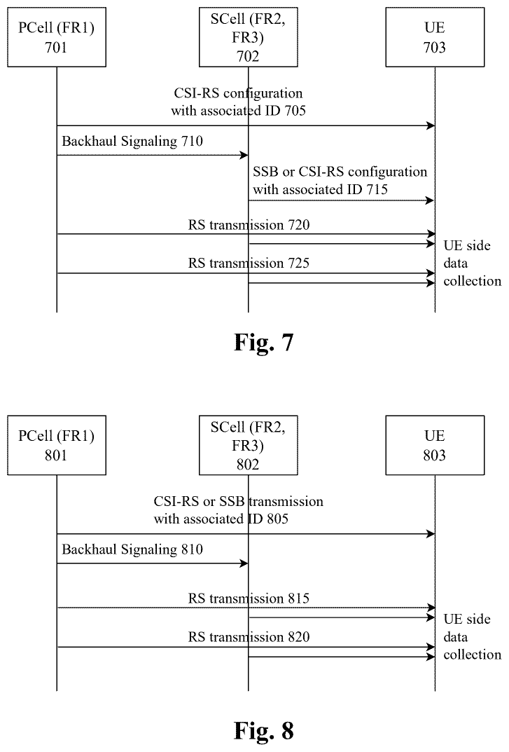

FIG. 7 shows a signaling diagram 700 for a first option for data collection for a UE side model for cross frequency beam measurement according to various example embodiments. The signaling diagram 700 includes a PCell 701 providing an FR1 component carrier, an SCell 702 providing an FR2 or FR3 CC, and a UE 703. The PCell 701 transmits to the UE 703 a CSI-RS configuration for the PCell 701 with an associated ID (705). The PCell 701 signals the SCell 702 by backhaul signaling to provide an SCell 702 configuration to the UE 703 (710) and the SCell 702 transmits to the UE 703 an SSB or CSI-RS configuration with the associated ID (715). The PCell 701 transmits RS to the UE 703 for data collection (720) and the SCell 702 transmits RS to the UE 703 for data collection (725).

In a second option, the PCell sends the configuration of PCell and SCell together, with corresponding association ID. It is noted that this option may be suitable in combination with an associated ID framework in which the PCell transmission parameters and the SCell transmission parameters are covered under a single ID, as described above.

FIG. 8 shows a signaling diagram 800 for a second option for data collection for a UE side model for cross frequency beam measurement according to various example embodiments. The signaling diagram 800 includes a PCell 801 providing an FR1 component carrier, an SCell 802 providing an FR2 or FR3 CC, and a UE 803. The PCell 801 transmits to the UE 803 a CSI-RS configuration for the PCell 801 and an SSB or CSI-RS configuration for the SCell 802 with an associated ID (805). The PCell 801 signals the SCell 802 by backhaul signaling to transmit RS to the UE 803 for data collection (810). The PCell 801 transmits RS to the UE 803 for data collection (815) and the SCell 802 transmits RS to the UE 803 for data collection (820).

In some embodiments, the detailed signaling procedure for inferencing is described. For inference, the UE measures RS transmission from the PCell. In some embodiments, the PCell configures the UE with a CSI-RS resource set and an associated ID.

SCell-related information should also be part of the PCell signaling to enable UE feedback of corresponding inference report. In some embodiments, the SCell related configuration includes an SSB burst configuration or a CSI-RS resource set configuration of the SCell. In some embodiments, the SSB burst configuration may include a number of SSB, location and index per SSB burst; an SSB periodicity; an SSB transmission time; and/or a number of SSB burst repetition.

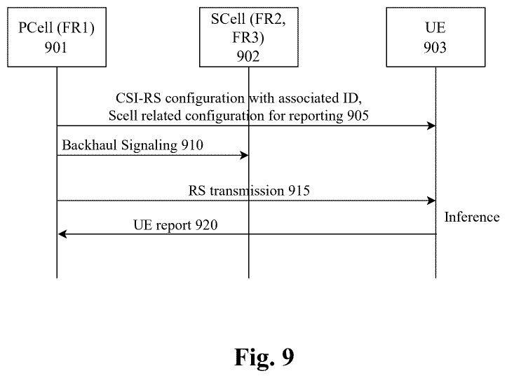

FIG. 9 shows a signaling diagram 900 for inference for a UE side model for cross frequency beam measurement according to various example embodiments. The signaling diagram 900 includes a PCell 901 providing an FR1 component carrier, an SCell 902 providing an FR2 or FR3 CC, and a UE 903. The PCell 901 transmits to the UE 903 a CSI-RS configuration for the PCell 901 and related configuration information (e.g., an SSB or CSI-RS configuration) for the SCell 902 with an associated ID (905). The PCell 901 signals the SCell 902 by backhaul signaling to prepare the SCell 902 for activation (910). The PCell 901 transmits RS to the UE 903 for inference (915). The UE 903 measures the RS and transmits an inference report (920).

In some embodiments, the SCell may be triggered to start SSB transmission if the PCell determines to activate the SCell. In some embodiments, the SCell may be OFF during the UE inferencing. When the SCell is OFF (no SSB transmission), the PCell may turn the SCell ON and trigger SSB transmission. In some embodiments, the SCell may be ON with a long SSB periodicity during the UE inferencing. When the SCell is ON, the PCell may trigger on-demand SSB to enable faster SCell activation. For the on-demand SSB transmission, only the predicted SSB beams are transmitted for measurement. This provides additional NW power saving and requires less UE measurements.

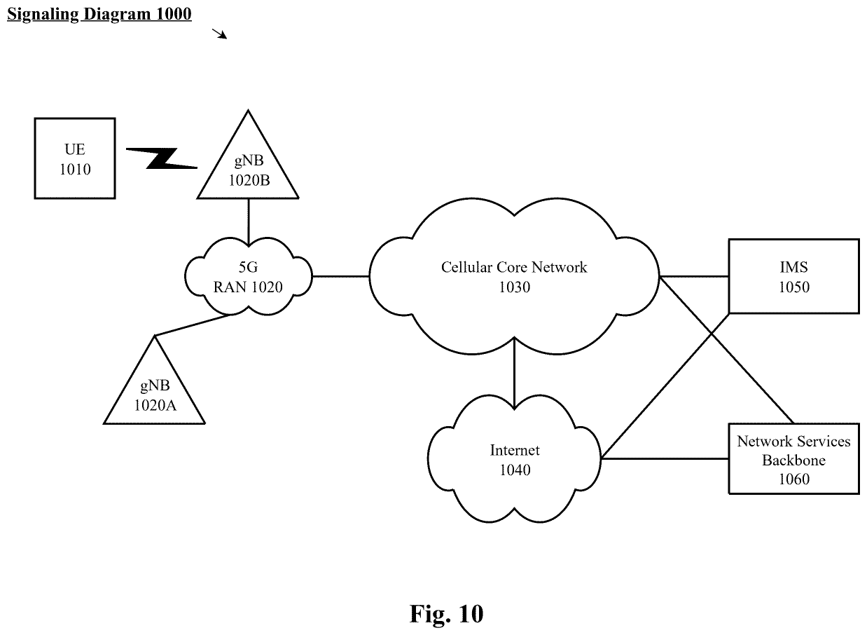

FIG. 10 shows an example network arrangement 1000 according to various example embodiments. The example network arrangement 1000 includes a UE 1010. The UE 1010 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 1010 is merely provided for illustrative purposes.

The UE 1010 may be configured to communicate with one or more networks. In the example of the network arrangement 1000, the network with which the UE 1010 may wirelessly communicate is a 5G NR radio access network (RAN) 1020. However, the UE 1010 may also communicate with other types of networks (e.g., 5G cloud RAN, a next generation RAN (NG-RAN), a legacy cellular network, etc.) and the UE 1010 may also communicate with networks over a wired connection. With regard to the example embodiments, the UE 1010 may establish a connection with the 5G NR RAN 1020. Therefore, the UE 1010 may have a 5G NR chipset to communicate with the NR RAN 1020.

The 5G NR RAN 1020 may be portions of a cellular network that may be deployed by a network carrier (e.g., Verizon, AT&T, T-Mobile, etc.). The RAN 1020 may include cells or base stations that are configured to send and receive traffic from UEs that are equipped with the appropriate cellular chip set. In this example, the 5G NR RAN 1020 includes the gNB 1020A and the gNB 1020B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 1010 to connect to the 5G NR RAN 1020. For example, as discussed above, the 5G NR RAN 1020 may be associated with a particular network carrier where the UE 1010 and/or the user thereof has a contract and credential information (e.g., stored on a SIM card). Upon detecting the presence of the 5G NR RAN 1020, the UE 1010 may transmit the corresponding credential information to associate with the 5G NR RAN 1020. More specifically, the UE 1010 may associate with a specific cell (e.g., gNB 1020B).

The network arrangement 1000 also includes a cellular core network 1030, the Internet 1040, an IP Multimedia Subsystem (IMS) 1050, and a network services backbone 10120. The cellular core network 1030 manages the traffic that flows between the cellular network and the Internet 1040. The IMS 1050 may be generally described as an architecture for delivering multimedia services to the UE 1010 using the IP protocol. The IMS 1050 may communicate with the cellular core network 1030 and the Internet 1040 to provide the multimedia services to the UE 1010. The network services backbone 1060 is in communication either directly or indirectly with the Internet 1040 and the cellular core network 1030. The network services backbone 1060 may be generally described as a set of components (e.g., servers, network storage arrangements, etc.) that implement a suite of services that may be used to extend the functionalities of the UE 1010 in communication with the various networks.

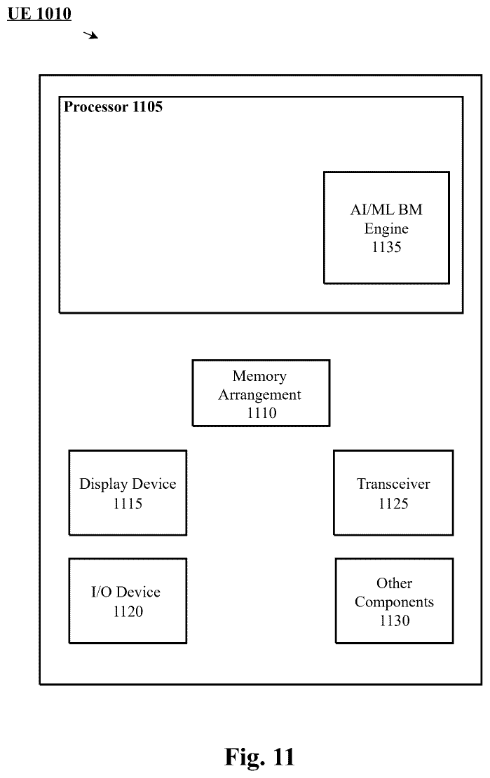

FIG. 11 shows an example UE 1010 according to various example embodiments. The UE 1010 will be described with regard to the network arrangement 1000 of FIG. 10. The UE 1010 may represent any electronic device and may include a processor 1105, a memory arrangement 1110, a display device 1115, an input/output (I/O) device 1120, a transceiver 1125, and other components 1130. The other components 1130 may include, for example, an audio input device, an audio output device, a battery that provides a limited power supply, a data acquisition device, ports to electrically connect the UE 1010 to other electronic devices, sensors to detect conditions of the UE 1010, etc.

The processor 1105 may be configured to execute a plurality of engines for the UE 1010. For example, the engines may include an AI/ML engine 1135 for performing operations related to model development for UE-side AI/ML models for the air interface, as described in detail above.

In some examples, beam measurement inputs may be fed to the AI/ML BM engine 1135. The AI/ML BM engine 1135 may include one or more learning-based and/or non-learning-based models for perceiving, synthesizing, and inferring information. The AI/ML BM engine 1135 may include any suitable number of processes to predict a beam in one frequency range based on input beam measurement data for another frequency range.

Persons of ordinary skill in the art will appreciate that the AI/ML BM engine 1135 may include any suitable machine learning models that are well-known or widely available such as regression techniques, classification techniques, neural networks, and deep learning networks. In instances where the AI/ML BM engine 1135 comprises a machine-learning based model, the AI/ML BM engine 1135 may be trained to predict a beam based on beam measurement data using one or more well-known or widely available training techniques such as supervised learning, semi-supervised learning, unsupervised learning, and/or reinforcement learning techniques. The training data may include the aforementioned beam measurement data.

The above referenced engine being an application (e.g., a program) executed by the processor 1105 is only an example. The functionality associated with the engines may also be represented as a separate incorporated component of the UE 1010 or may be a modular component coupled to the UE 1010, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 1105 is split among two or more processors such as a baseband processor and an applications processor. The example embodiments may be implemented in any of these or other configurations of a UE.

The memory arrangement 1110 may be a hardware component configured to store data related to operations performed by the UE 1010. The display device 1115 may be a hardware component configured to show data to a user while the I/O device 1120 may be a hardware component that enables the user to enter inputs. The display device 1115 and the I/O device 1120 may be separate components or integrated together such as a touchscreen.

The transceiver 1125 may be a hardware component configured to establish a connection with the 5G NR-RAN 1020, an LTE-RAN (not pictured), a legacy RAN (not pictured), a WLAN (not pictured), etc. Accordingly, the transceiver 1125 may operate on a variety of different frequencies or channels (e.g., set of consecutive frequencies). The transceiver 1125 includes circuitry configured to transmit and/or receive signals (e.g., control signals, data signals). Such signals may be encoded with information implementing any one of the methods described herein. The processor 1105 may be operably coupled to the transceiver 1125 and configured to receive from and/or transmit signals to the transceiver 1125. The processor 1105 may be configured to encode, decode and/or process signals (e.g., signaling from a base station of a network) for implementing any one of the methods described herein.

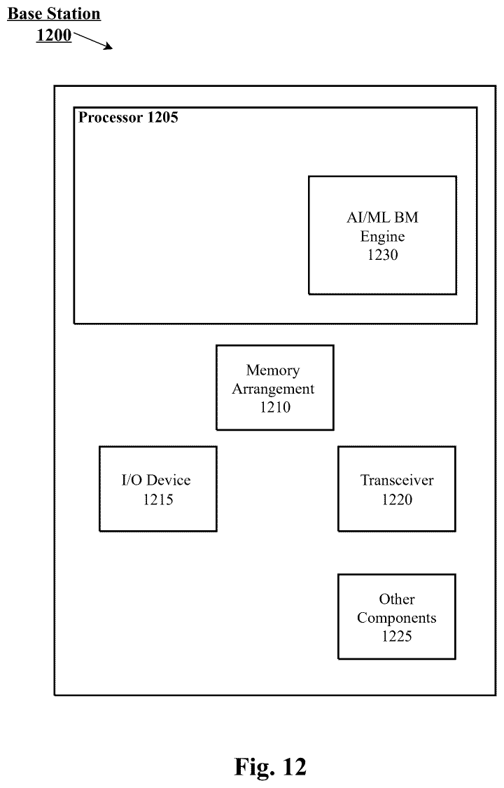

FIG. 12 shows an example base station 1200 according to various example embodiments. The base station 1200 may represent the gNB 1020A, the gNB 1020B or any other access node through which the UE 1010 may establish a connection and manage network operations. The base station 1200 may operate as the MN or the SN as described in the examples above.

The base station 1200 may include a processor 1205, a memory arrangement 1210, an input/output (I/O) device 1215, a transceiver 1220, and other components 1225. The other components 1225 may include, for example, an audio input device, an audio output device, a battery, a data acquisition device, ports to electrically connect the base station 1200 to other electronic devices and/or power sources, etc.

The processor 1205 may be configured to execute a plurality of engines for the base station 1200. For example, the engines may include an AI/ML BM engine 1230 for performing operations related to model development for UE-side AI/ML models for the air interface, as described in detail above.

The memory arrangement 1210 may be a hardware component configured to store data related to operations performed by the base station 1200. The I/O device 1215 may be a hardware component or ports that enable a user to interact with the base station 1200.

The transceiver 1220 may be a hardware component configured to exchange data with the UE 1010 and any other UE in the network arrangement 1000. The transceiver 1220 may operate on a variety of different frequencies or channels (e.g., set of consecutive frequencies). The transceiver 1220 includes circuitry configured to transmit and/or receive signals (e.g., control signals, data signals). Such signals may be encoded with information implementing any one of the methods described herein. The processor 1205 may be operably coupled to the transceiver 1220 and configured to receive from and/or transmit signals to the transceiver 1220. The processor 1205 may be configured to encode, decode and/or process signals (e.g., signaling from a UE) for implementing any one of the methods described herein.

### EXAMPLES

In a first example, a method, comprising generating, for transmission to a network, a capability report indicating support of cross frequency beam prediction by a model stored in the memory, processing, based on signaling from the network, a configuration for reporting applicable functionalities for the model, the configuration including at least a first associated identifier (ID), the first associated ID associated with beam transmission parameters by a first cell of the network providing a first component carrier (CC) in a first frequency band and with beam transmission parameters by a second cell of the network providing a second CC in a second frequency band and generating, for transmission to the network, a response indicating the applicable functionalities based at least in part on the first associated ID.

In a second example, the method of the first example, wherein the first associated ID is associated with a mapping of antenna ports to physical antennas used by the first cell and with a beam codebook used by the second cell.

In a third example, the method of the second example, wherein the first associated ID comprises a first ID for the mapping of the first cell in combination with a second ID for the beam codebook of the second cell.

In a fourth example, the method of the second example, wherein the first associated ID comprises a single ID for the mapping of the first cell and the beam codebook of the second cell.

In a fifth example, the method of the first example, further comprising determining the applicable functionalities based on the associated ID and whether the model stored in the memory is associated with the associated ID.

In a sixth example, the method of the fifth example, further comprising determining the applicable functionalities based on deployment conditions of the apparatus.

In a seventh example, the method of the sixth example, wherein the deployment conditions include a line of sight (LOS) condition or a non-line of sight (NLOS) condition.

In an eighth example, the method of the sixth example, wherein the deployment conditions include an indoor condition or an outdoor condition.

In a ninth example, the method of the sixth example, wherein the deployment conditions include a mobility condition.

In a tenth example, the method of the sixth example, wherein the deployment conditions include a location condition.

In an eleventh example, the method of the fifth example, further comprising determining the applicable functionalities based on additional information included in the configuration indicating network conditions.

In a twelfth example, the method of the first example, wherein the configuration includes a first channel state information reference signal (CSI-RS) resource set configuration for measuring the first CC and the first associated ID, the configuration further including synchronization signal block (SSB) related information or a second CSI-RS resource set configuration for the second CC for inference reporting for the second CC.

In a thirteenth example, the method of the twelfth example, wherein the SSB related information includes a SSB burst configuration comprising a number of SSB, a location, an index per SSB burst, an SSB periodicity, an SSB transmission time and a number of SSB burst repetitions.

In a fourteenth example, the method of the first example, wherein the capability report includes one or more combinations of frequency ranges supported for cross frequency beam prediction.

In a fifteenth example, the method of the fourteenth example, wherein the capability report includes at least one of a first combination in which a frequency range 1 (FR1) band is measured to predict a frequency range 2 (FR2) band, a second combination in which the FR1 band is measured to predict a frequency range 3 (FR3) band, or a third combination in which the FR3 band is measured to predict the FR2 band.

In a sixteenth example, the method of the first example, wherein the capability report includes one or more combinations of antenna port configurations supported for cross frequency beam prediction.

In a seventeenth example, the method of the sixteenth example, wherein the capability report includes at least one of a first combination in which the first cell transmits with 32 ports for predicting 16 beams of the second cell, a second combination in which the first cell transmits with 64 for predicting 16 beams of the second cell, or a third combination in which the first cell transmits with 64 ports for predicting 32 beams of the second cell.

In an eighteenth example, the method of the first example, wherein the capability report includes a combination in which, the first cell transmits downlink channel state information reference signal (CSI-RS) for predicting an uplink sounding reference signal (SRS) beam in a frequency domain duplexing (FDD) band.

In a nineteenth example, the method of the first example, further comprising measuring, based on signaling from the first cell, first reference signals (RS), generating, for transmission to the first cell, an inference report including predicted beams of the second cell and processing, based on signaling from the second cell, on demand synchronization signal blocks (SSB) for activating the second cell.

In a twentieth example, a processor configured to perform any of the methods of the first through nineteenth examples.

In a twenty first example, a user equipment (UE) configured to perform any of the methods of the first through nineteenth examples.

In a twenty second example, a method, comprising processing, based on signaling from the network, a configuration for data collection for training a model for cross frequency beam prediction, the configuration at least including a first reference signal (RS) configuration for a first cell of the network providing a first component carrier (CC), a second RS configuration for a second cell of the network providing a second CC, and a first associated identifier (ID), the first associated ID associated with beam transmission parameters by the first cell in a first frequency band and with beam transmission parameters by the second cell in a second frequency band, measuring, based on signaling from the first cell, first RS to generate first RS measurements, measuring, based on signaling from the second cell, second RS to generate second RS measurements and storing the first RS measurements and the second RS measurements in association with the associated ID.

In a twenty third example, the method of the twenty second example, wherein the first RS configuration is signaled to the apparatus by the first cell and the second RS configuration is signaled to the apparatus by the second cell.

In a twenty fourth example, the method of the twenty third example, wherein the first RS configuration includes an association between the first cell and the second cell.

In a twenty fifth example, the method of the twenty third example, wherein the first RS configuration includes an association between the first cell and the second cell and the second RS configuration includes an association between the first cell and the second cell.

In a twenty sixth example, the method of the twenty second example, wherein the first RS configuration and the second RS configuration is signaled to the apparatus by the first cell.

In a twenty seventh example, the method of the twenty second example, wherein the second RS configuration includes one or more beam indices comprising a synchronization signal block resource indicator (SSBRI) or a channel state information reference signal (CSI-RS) resource indicator (CRI).

In a twenty eighth example, the method of the twenty second example, wherein the first associated ID is associated with a mapping of antenna ports to physical antennas used by the first cell and with a beam codebook used by the second cell.

In a twenty ninth example, the method of the twenty eight example, wherein the first associated ID comprises a first ID for the mapping of the first cell in combination with a second ID for the beam codebook of the second cell.

In a thirtieth example, the method of the twenty eight example, wherein the first associated ID comprises a single ID for the mapping of the first cell and the beam codebook of the second cell.

In a thirty first example, the method of the twenty second example, wherein for Frequency Range 3 (FR3), a second ID represents an antenna port or an FR3 codebook for beamforming.

In a thirty second example, a processor configured to perform any of the methods of the twenty second through thirty first examples.

In a thirty third example, a user equipment (UE) configured to perform any of the methods of the twenty second through thirty first examples.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

Some embodiments described herein may include use of learning and/or non-learning-based process(es). The use may include collecting, pre-processing, encoding, labeling, organizing, analyzing, recommending, and/or generating data. Entities that collect, share, and/or otherwise utilize user data should provide transparency and/or obtain user consent when collecting such data. The present disclosure recognizes that the use of the data in the AI/ML beam management processes may be used to benefit users.

For example, the data may be used to train models that may be deployed to improve performance, accuracy, and/or functionality of applications and/or services. Accordingly, the use of the data enables the AI/ML beam management processes to adapt and/or optimize operations to provide more personalized, efficient, and/or enhanced user experiences. Such adaptation and/or optimization may include tailoring content, recommendations, and/or interactions to individual users, as well as streamlining processes, and/or enabling more intuitive interfaces. Further beneficial uses of the data in the AI/ML beam management processes are also contemplated by the present disclosure.

The present disclosure contemplates that, in some example embodiments, data used by AI/ML beam management processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML beam management processes, should attempt to comply with well-established privacy policies and/or privacy practices.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising memory coupled to processing circuitry, the processing circuitry configured to:
generate, for transmission to a network, a capability report indicating support of cross frequency beam prediction by a model stored in the memory;
process, based on signaling from the network, a configuration for reporting applicable functionalities for the model, the configuration including at least a first associated identifier (ID), the first associated ID associated with beam transmission parameters by a first cell of the network providing a first component carrier (CC) in a first frequency band and with beam transmission parameters by a second cell of the network providing a second CC in a second frequency band; and
generate, for transmission to the network, a response indicating the applicable functionalities based at least in part on the first associated ID.

2. The apparatus of claim 1, wherein the first associated ID is associated with a mapping of antenna ports to physical antennas used by the first cell and with a beam codebook used by the second cell.

3. The apparatus of claim 2, wherein the first associated ID comprises a first ID for the mapping of the first cell in combination with a second ID for the beam codebook of the second cell.

4. The apparatus of claim 2, wherein the first associated ID comprises a single ID for the mapping of the first cell and the beam codebook of the second cell.

5. The apparatus of claim 1, wherein the processing circuitry is further configured to:
determine the applicable functionalities based on the associated ID and whether the model stored in the memory is associated with the associated ID.

6. The apparatus of claim 5, wherein the processing circuitry is further configured to:
determine the applicable functionalities based on deployment conditions of the apparatus.

7. The apparatus of claim 6, wherein the deployment conditions include a line of sight (LOS) condition or a non-line of sight (NLOS) condition.

8. The apparatus of claim 6, wherein the deployment conditions include an indoor condition or an outdoor condition.

9. The apparatus of claim 6, wherein the deployment conditions include a mobility condition.

10. The apparatus of claim 6, wherein the deployment conditions include a location condition.

11. The apparatus of claim 5, wherein the processing circuitry is further configured to:
determine the applicable functionalities based on additional information included in the configuration indicating network conditions.

12. The apparatus of claim 1, wherein the configuration includes a first channel state information reference signal (CSI-RS) resource set configuration for measuring the first CC and the first associated ID, the configuration further including synchronization signal block (SSB) related information or a second CSI-RS resource set configuration for the second CC for inference reporting for the second CC.

13. The apparatus of claim 12, wherein the SSB related information includes a SSB burst configuration comprising a number of SSB, a location, an index per SSB burst, an SSB periodicity, an SSB transmission time and a number of SSB burst repetitions.

14. The apparatus of claim 1, wherein the capability report includes one or more combinations of frequency ranges supported for cross frequency beam prediction.

15. The apparatus of claim 14, wherein the capability report includes at least one of a first combination in which a frequency range 1 (FR1) band is measured to predict a frequency range 2 (FR2) band, a second combination in which the FR1 band is measured to predict a frequency range 3 (FR3) band, or a third combination in which the FR3 band is measured to predict the FR2 band.

16. The apparatus of claim 1, wherein the capability report includes one or more combinations of antenna port configurations supported for cross frequency beam prediction.

17. The apparatus of claim 16, wherein the capability report includes at least one of a first combination in which the first cell transmits with 32 ports for predicting 16 beams of the second cell, a second combination in which the first cell transmits with 64 for predicting 16 beams of the second cell, or a third combination in which the first cell transmits with 64 ports for predicting 32 beams of the second cell.

18. The apparatus of claim 1, wherein the capability report includes a combination in which, the first cell transmits downlink channel state information reference signal (CSI-RS) for predicting an uplink sounding reference signal (SRS) beam in a frequency domain duplexing (FDD) band.

19. The apparatus of claim 1, wherein the processing circuitry is further configured to:
measure, based on signaling from the first cell, first reference signals (RS);
generate, for transmission to the first cell, an inference report including predicted beams of the second cell; and
process, based on signaling from the second cell, on demand synchronization signal blocks (SSB) for activating the second cell.

20. An apparatus comprising memory coupled to processing circuitry, the processing circuitry configured to:
process, based on signaling from the network, a configuration for data collection for training a model for cross frequency beam prediction, the configuration at least including a first reference signal (RS) configuration for a first cell of the network providing a first component carrier (CC), a second RS configuration for a second cell of the network providing a second CC, and a first associated identifier (ID), the first associated ID associated with beam transmission parameters by the first cell in a first frequency band and with beam transmission parameters by the second cell in a second frequency band;
measure, based on signaling from the first cell, first RS to generate first RS measurements;
measure, based on signaling from the second cell, second RS to generate second RS measurements; and
store the first RS measurements and the second RS measurements in association with the associated ID.
